(19) United States
(12) Patent Application Publication
(10) Pub. No.: US 2010/0230638 A1
(43) Pub. Date: Sep. 16, 2010

(54) Sealant for One Drop Fill Process, Transfer Material, and Liquid Crystal Display Element

(76) Inventor: Masanori Matsuda, Shiga (JP)

Correspondence Address: WENDEROTH, LIND & PONACK, L.L.P., 1030 15th Street, N.W.,, Suite 400 East, Washington, DC, 20005-1503, US

(21) Appl. No.: 12/225,253

(22) PCT Filed: Mar. 28, 2007
(86) PCT No.: PCT/JP2007/056706

§ 371 Date: Oct. 30, 2008

(30) Foreign Application Priority Data
Mar. 29, 2006 (JP) 2006-091040
Oct. 20, 2006 (JP) 2006-286340
Oct. 23, 2006 (JP) 2006-288022

(51) Int. Cl. H01B 1/12; C08L 33/02; G02F 1/1339

(52) U.S. Cl. 252/500; 525/379; 525/375; 525/381; 525/351; 525/206

(57) ABSTRACT

The present invention aims to provide a sealant for one drop fill process, having an excellent pot life, hardly contaminating a liquid crystal, making it possible to produce a liquid crystal display device with high quality display images, and also provide a transfer material and a liquid crystal display element.

A sealant for one drop fill process which comprises a (meth)acrylic resin and/or a cyclic ether group-containing resin, and a heat-curing agent having a structure represented by the following general formula (1):

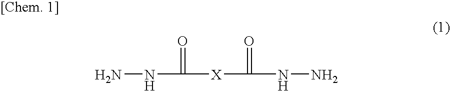

in the formula (1), X represents a structure represented by (CHR)ₙ, R represents OH and/or H, and n represents an integer of 0 to 3.

### TECHNICAL FIELD

The present invention relates to a sealant for one drop fill process, having an excellent pot life, hardly contaminating a liquid crystal, making it possible to produce a liquid crystal display device with high quality display images, and also relates to a transfer material and a liquid crystal display element.

### BACKGROUND ART

In recent years, a liquid crystal display panel has come to be widely used as a display panel for various devices such as a flat television, a personal computer, and a cellular phone.

A production method of a liquid crystal display element such as a liquid crystal display panel has been shifted from a conventional vacuum injection method to a liquid crystal dropping method known as one drop fill process using a sealant composed of a cured resin composition, for the purpose of reducing takt time. In the one drop fill process, first, a rectangular seal pattern is formed by dispensing the sealant on one of two transparent substrates having an electrode. Next, in a state the sealant is not yet cured, small droplets of a liquid crystal are dropped and applied to the entire face within a frame of the transparent substrate, immediately followed by lamination of the other substrate thereon, and then the seal part is irradiated with ultraviolet rays to temporarily cure the sealant. After that, heating is carried out at the time of liquid crystal annealing to fully cure the seal part so that a liquid crystal display element is produced. When the lamination of the substrates is carried out in a reduced pressure, it is possible to produce the liquid crystal display element at an extremely high efficiency. The one drop fill process is expected to become the mainstream production method of a liquid crystal display device in the future. In the production of a liquid crystal display device according to the one drop fill process as mentioned above, an one-package type light- and heat-curing sealant to be cured by a combination of ultraviolet rays and heating is used.

Conventionally, when a liquid crystal display element is produced by one drop fill process using the light- and heat-curing sealant, the liquid crystal is sometimes contaminated due to direct contact with the sealant which is uncured or temporarily cured by light irradiation, causing a reduction in the relative dielectric constant of the liquid crystal. In order to prevent the contamination of the liquid crystal as mentioned above, the sealant to be used is preferably of the kind that is cured at a temperature as low as possible. However, the sealant that cures at a low temperature starts curing upon use to increase the viscosity, causing a problem of a short pot life.

Meanwhile, the curing temperature of the sealant is determined depending on the kind of heat-curing agent to be contained therein. As an example of a heat-curing agent having a high reactivity and an excellent pot life, Patent document 1 discloses a boric acid ester compound and a hydrazide having a valine hydantoin skeleton. In fact, however, the hydrazide having a hydantoin skeleton has a short pot life, and can be categorized in those causing short pot life, and can be categorized in those causing worse contamination of liquid crystals as compared to other hydrazides due to its high solubility in liquid crystals.

Moreover, a sealant containing, as a heat-curing agent, a commonly known hydrazide such as adipic acid dihydrazide (ADH) or sebacic dihydrazide (SDH) causes a problem that much small light leakage occurs in the vicinity of the cured sealant for a liquid crystal display element produced by one drop fill process.

To deal with those problems, use of a sealant containing, for example, 1,3-bis(hydrazinocarboethyl)-5-isopropylhydantoin (VDH) or isophthalic dihydrazide (IDH) as a heat-curing agent can prevent the occurrence of much small light leakage in the vicinity of the cured sealant for the liquid crystal display element produced by one drop fill process. However, the aforementioned sealant has problems of a shorter pot life and a lower heat-curing property.

For this reason, as a sealant for use in the one drop fill process, there has been a demand for a sealant which does not cause contamination of a liquid crystal as well as has an improved pot life.

Patent Document 1: Japanese Kokai Publication No. 2005-115255

### DISCLOSURE OF THE INVENTION

### Problems to be Solved by the Invention;

In view of the above-mentioned current situation, the present invention aims to provide a sealant for one drop fill process, having an excellent pot life, hardly contaminating a liquid crystal, making it possible to produce a liquid crystal display device with high quality display images, and also provide a transfer material and a liquid crystal display element.

### Means for Solving the Problems

A first present invention is a sealant for one drop fill process, which comprises a (meth)acrylic resin and/or a cyclic ether group-containing resin, and a heat-curing agent having a structure represented by the following general formula (1):

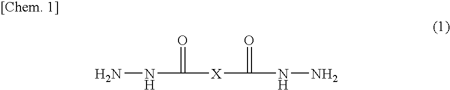

in the formula (1), X represents a structure represented by (CHR)ₙ, R represents OH and/or H, and n represents an integer of 0 to 3.

A second present invention is a sealant for one drop fill process, which comprises a (meth)acrylic resin and/or a cyclic ether group-containing resin, and at least one kind of a heat-curing agent selected from the group consisting of the following chemical formulae (2) to (11):

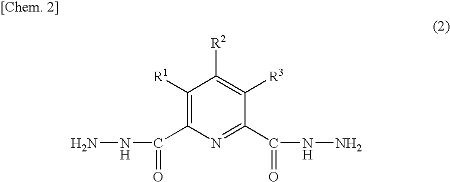

in the formula (2), R¹, R² and R³ each represents any of H, (CH₂)ₙCH₃, OH, COOH and NH₂, and n represents an integer of 0 to 2,

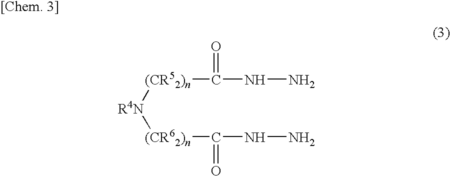

in the formula (3), R⁴, R⁵ and R⁶ each represents any of H, (CH₂)ₙCH₃, OH, COOH and NH₂, and n represents an integer of 4 or less,

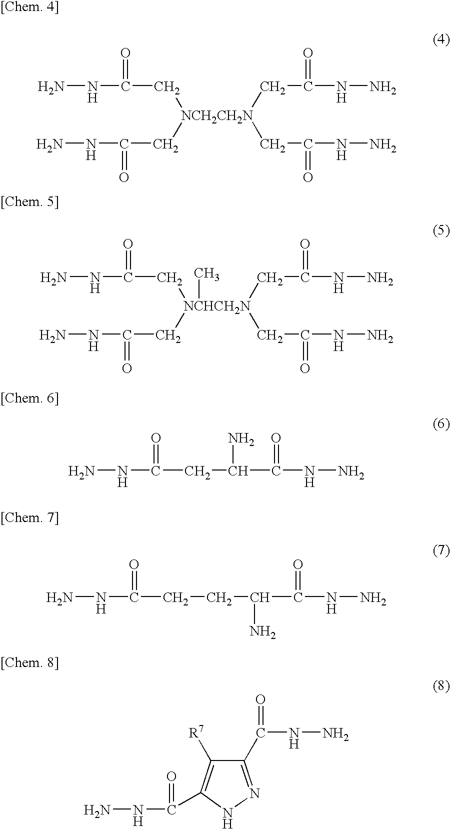

in the formula (8), R⁷ represents any of H, (CH₂)ₙCH₃, OH, COOH and NH₂, and n represents an integer of 0 to 2,

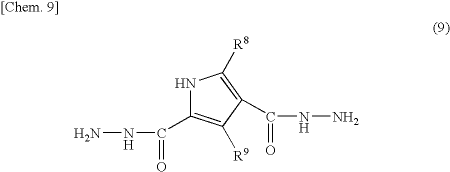

in the formula (9), R⁸ and R⁹ each represents any of H, (CH₂)ₙCH₃, OH, COOH and NH₂, and n represents an integer of 0 to 2,

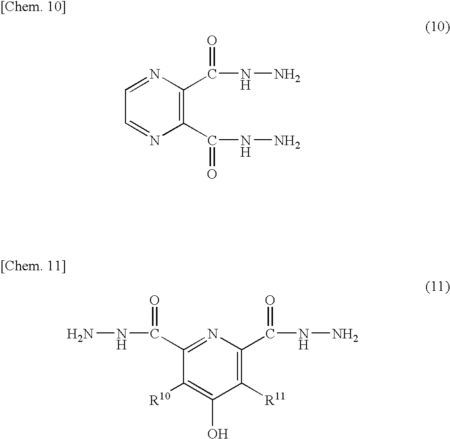

in the formula (11), R¹⁰ and R¹¹ each represents any of H, (CH₂)ₙCH₃, OH, COOH and NH₂, and n represents an integer of 0 to 2.

A third present invention is a sealant for one drop fill process, which comprises a (meth)acrylic resin and/or a cyclic ether group-containing resin, and at least one kind of a heat-curing agent selected from the group consisting of the following chemical formulae (12) to (15):

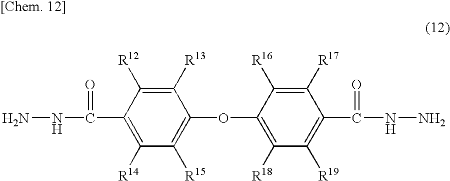

in the formula (12), R¹² to R¹⁹ each represents any of H, (CH₂)ₙCH₃, OH, COOH and NH₂, and n represents an integer of 0 to 2,

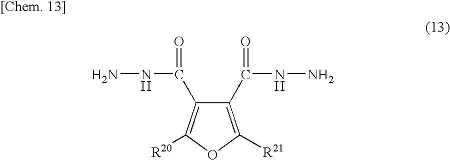

in the formula (13), R²⁰ and R²¹ each represents any of H, (CH₂)ₙCH₃, OH, COOH and NH₂, and n represents an integer of 0 to 2,

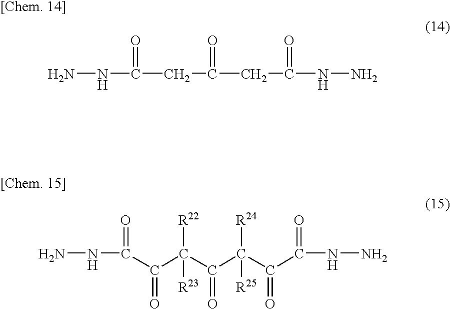

in the formula (15), R²² to R²⁵ each represents any of H, (CH₂)ₙCH₃, OH, COOH and NH₂, and n represents an integer of 0 to 2.

A fourth present invention is a sealant for one drop fill process, which comprises a (meth)acrylic resin and/or a cyclic ether group-containing resin, and a heat-curing agent having a structure represented by the following chemical formula (16):

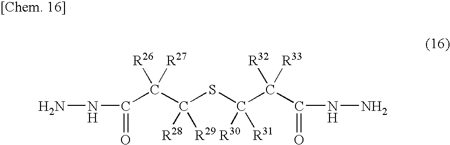

in the formula (16), R²⁶ to R³³ each represents any of H, (CH₂)ₙCH₃, OH, COOH and NH₂, and n represents an integer of 0 to 2.

The following description will discuss the present inventions in more detail.

Meanwhile, the sealant for one drop fill process according to the first present invention, the sealant for one drop fill process according to the second present invention, the sealant for one drop fill process according to the third present invention and the sealant for one drop fill process according to the fourth present invention will be collectively referred to as a “sealant of the present invention” in the following description, upon discussing a common item among them.

The inventors of the present invention made intensive investigations, and found that, when a hydrazide compound with a low compatibility with a light- or a heat-curing resin as a heat-curing agent is contained in a heat- and light-curing sealant for use in the production of the liquid crystal display by one drop fill process, and additionally, the hydrazide compound with a specific structure is used, it is possible to produce a liquid crystal display element, which can simultaneously achieve an improved pot life and no contamination of the liquid crystal, and can also achieve high quality display images. Accordingly, they have completed the present invention.

The sealant for one drop fill process according to the first present invention includes the heat-curing agent represented by the aforementioned general formula (1); the sealant for one drop fill process according to the second present invention includes at least one kind of a heat-curing agent selected from the group consisting of the aforementioned chemical formulae (2) to (11); the sealant for one drop fill process according to the third present invention includes at least one kind of a heat-curing agent selected from the group consisting of the aforementioned chemical formulae (12) to (15); and the sealant for one drop fill process according to the fourth present invention includes a heat-curing agent represented by the aforementioned chemical formula (16). Each of the heat-curing agents in the first, second, third and fourth present inventions functions to cure the respective sealants of the present invention by causing the reaction of a (meth)acrylic group in a (meth)acrylic resin or a cyclic ether group in a cyclic ether group-containing resin, which will be mentioned below, in the sealant of the present invention upon exposure to heat to form a cross-linking so that the adhesive property and the moisture resistance of the cured sealant of the present invention are improved.

The heat-curing agents represented by the aforementioned general formulae (1) to (16) are compounds which have a low compatibility with a below-mentioned (meth)acrylic resin or a cyclic ether group-containing resin, notably with a cyclic ether group-containing resin, and have a melting point of 100° C. or more. Therefore, the sealants according to the present invention do not cure almost at all until the heat-curing agents are heated to the melting point or more, with the result that an excellent pot life is obtained. Moreover, since the heat-curing agents contain two highly reactive hydrazide groups in one molecule, the curing property itself is excellent. Furthermore, since the number of carbon between the hydrazide groups is limited to the specific range (n=0 to 3) in the heat-curing agent represented by the aforementioned general formula (1), the heat-curing agent has a low compatibility with a liquid crystal and thus hardly contaminates the liquid crystal.

In the heat-curing agent represented by the general formula (1), the lower limit of n is 0 and the upper limit of n is 3. In the case where the n is 4 or more, a liquid crystal display element formed by using the sealant of the first present invention may have small light leakage in the vicinity of the cured sealant of the first present invention and the liquid crystal.

Among the heat-curing agents represented by the general formula (1), an example of the heat-curing agent in which n=0 is oxalic acid dihydrazide; an example of the heat-curing agent in which n=1 is malonic acid dihydrazide; examples of the heat-curing agent in which n=2 include tartaric acid dihydrazide, malic acid dihydrazide and succinic acid dihydrazide; and an example of the heat-curing agent in which n=3 is glutamic acid dihydrazide, and the like.

Meanwhile, in the production of the liquid crystal display device using a sealant, there may be a case that a heated glass is not sufficiently cooled when the sealant is applied to the glass substrate. For example, when a conventional sealant is applied to a glass substrate having a temperature of approximately 50° C., the components of the sealant are eluted in some cases so that contamination such as light leakage occurs in the produced liquid crystal display. On the other hand, as for the sealant of the present invention containing the heat-curing agent represented by any of the aforementioned general formulae (1) to (16), elution of the components of the sealant in the liquid crystal does not occur even in the case where the sealant is applied to an insufficiently cooled glass substrate having a temperature of approximately 50° C., thus making it possible to prevent the occurrence of contamination such as light leakage in a liquid crystal display device to be produced.

Furthermore, when a conventional sealant is used for vacuum lamination in the production of the liquid crystal display, in some cases the components of the sealant are eluted so that contamination such as light leakage occurs in the produced liquid crystal display when a high vacuum status is kept for a long period of time. On the other hand, as for the sealant of the present invention containing the heat-curing agent represented by any of the aforementioned general formulae (1) to (16), even if the aforementioned high vacuum state is kept for a long period of time, it is possible to prevent the occurrence of contamination such as light leakage in a liquid crystal display device to be produced.

Among the aforementioned heat-curing agents, the heat-curing agent represented by the following chemical formula (17) is preferable.

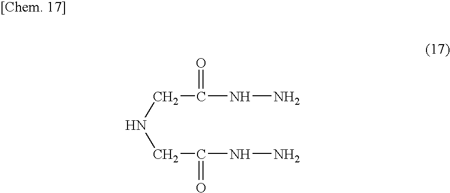

Although, the amount of the heat-curing agent to be mixed in the sealant of the present invention is not particularly limited, a preferable lower limit is 1 part by weight and a preferable upper limit is 30 parts by weight to 100 parts by weight of the sum of the (meth)acrylic resin and the cyclic ether group-containing resin to be mentioned below. The amount outside the range reduces the adhesiveness of the cured sealant of the present invention, and thus possibly accelerates deterioration of the properties of the liquid crystal of the liquid crystal display element formed by using the sealant of the present invention in a high temperature and high humidity operation test. A more preferable lower limit is 2 parts by weight, and a more preferable upper limit is 10 parts by weight.

The sealant of the present invention contains a (meth)acrylic resin and/or a cyclic ether group-containing resin. The (meth)acrylic resin refers to a methacrylic resin and an acrylic resin.

Preferable examples of the (meth)acrylic resin include a ester compound obtainable by a reaction of the (meth)acrylic acid with a compound having a hydroxyl group, epoxy(meth)acrylate obtainable by a reaction of the (meth)acrylic acid with an epoxy compound, and urethane (meth)acrylate obtainable by a reaction of isocyanate with a (meth)acrylic acid derivative having a hydroxyl group, and the like.

The ester compound obtainable by the reaction of the (meth)acrylic acid with the compound having a hydroxyl group is not particularly limited. Examples of the ester compound with a monofunctional group include 2-hydroxyethyl (meth)acrylate, 2-hydroxypropyl (meth)acrylate, 4-hydroxybutyl (meth)acrylate, 2-hydroxybutyl (meth)acrylate, isobutyl (meth)acrylate, t-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, ethylcarbitol (meth)acrylate, phenoxyethyl (meth)acrylate, phenoxy diethylene glycol (meth)acrylate, phenoxy polyethylene glycol (meth)acrylate, methoxy polyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, n-butyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethyl aminoethyl (meth)acrylate, dimethylaminoethyl (meth)acrylate, 2-(meth)acryloyloxyethyl succinic acid, 2-(meth)acryloyloxyethyl hexahydrophthalic acid, 2-(meth)acryloyloxyethyl 2-hydroxypropyl phthalate, glycidyl (meth)acrylate, 2-(meth)acryloyloxyethyl phosphate, and the like.

Examples of the ester compound with a difunctional group include 1,4-butanediol di(meth)acrylate, 1,3-butanediol di(meth)acrylate, 1,6-hexanediol di(meth)acrylate, 1,9-nonanediol di(meth)acrylate, 1,10-decanediol di(meth)acrylate, 2-n-butyl-2-ethyl-1,3-propanediol di(meth)acrylate, dipropyleneglycol di(meth)acrylate, tripropyleneglycol di(meth)acrylate, polypropyleneglycol (meth)acrylate, ethyleneglycol di(meth)acrylate, diethyleneglycol di(meth)acrylate, tetraethyleneglycol di(meth)acrylate, polyethyleneglycol di(meth)acrylate, propylene oxide-added bisphenol A di(meth)acrylate, ethylene oxide-added bisphenol A di(meth)acrylate, ethylene oxide-added bisphenol F di(meth)acrylate, dimethylol dicyclopentadiene di(meth)acrylate, 1,3-butyleneglycol di(meth)acrylate, neopentylglycol di(meth)acrylate, ethyleneoxide-modified isocyanuric acid di(meth)acrylate, 2-hydroxy-3-(meth)acryloyloxypropyl (meth)acrylate, carbonate diol di(meth)acrylate, polyetherdiol di(meth)acrylate, polyesterdiol di(meth)acrylate, polycaprolactonediol di(meth)acrylate, polybutadienediol di(meth)acrylate, and the like.

Examples of the ester compound with a tri- or more-functional group include pentaerythritol tri(meth)acrylate, trimethylolpropane tri(meth)acrylate, propyleneoxide-added trimethylolpropane tri(meth)acrylate, ethyleneoxide-added trimethylolpropane tri(meth)acrylate, caprolactone-modified trimethylolpropane tri(meth)acrylate, ethyleneoxide-added isocyanuric acid tri(meth)acrylate, dipentaerythritol penta(meth)acrylate, dipentaerythritol hexa(meth)acrylate, ditrimethylolpropane tetra(meth)acrylate, pentaerythritol tetra(meth)acrylate, glycerine tri(meth)acrylate, propyleneoxide-added glycerine tri(meth)acrylate, tris(meth)acryloyloxyethyl phosphate, and the like.

The epoxy (meth)acrylate obtainable by reaction of the (meth)acrylic acid with the epoxy compound is not particularly limited, and an epoxy (meth)acrylate obtainable by reaction of an epoxy resin with (meth)acrylic acid in the presence of a basic catalyst according to a known method, may be exemplified. The epoxy(meth)acrylate is preferably a fully-acrylated compound in which almost 100% of the epoxy groups are converted to acrylic groups.

The epoxy compound to be used as a material for synthesizing the epoxy (meth)acrylate is not particularly limited, and examples of the epoxy compound available in the market include: bisphenol A type epoxy resins such as Epikote 828EL and Epikote 1004 (all manufactured by Japan Epoxy Resin Co., Ltd.); bisphenol F type epoxy resins such as Epikote 806 and Epikote 4004 (all manufactured by Japan Epoxy Resin Co., Ltd.); bisphenol S type epoxy resins such as Epiclon EXA1514 (manufactured by Dainippon Ink and Chemicals Inc.); 2,2′-diallyl bisphenol A type epoxy resins such as RE-810NM (manufactured by Nippon Kayaku Co., Ltd.); hydrogenated bisphenol type epoxy resins such as Epiclon EXA7015 (manufactured by Dainippon Ink and Chemicals Inc.); propyleneoxide-added bisphenol A type epoxy resins such as EP-4000S (manufactured by ADEKA Corporation); resorcinol type epoxy resins such as EX-201 (manufactured by Nagase ChemteX Corporation); biphenyl type epoxy resins such as Epikote YX-4000H (manufactured by Japan Epoxy Resin Co., Ltd.); sulfide type epoxy resins such as YSLV-50TE (manufactured by Tohto Kasei Co., Ltd.); ether type epoxy resins such as YSLV-80DE (manufactured by Tohto Kasei Co., Ltd.); dicyclopentadiene type epoxy resins such as EP-4088S (manufactured by ADEKA Corporation); naphthalene type epoxy resins such as Epiclon HP4032 and Epiclon EXA-4700 (all manufactured by Dainippon Ink and Chemicals Inc.); phenol novolak type epoxy resins such as Epiclon N-770 (manufactured by Dainippon Ink and Chemicals Inc.); orthocresol novolak type epoxy resins such as Epiclon N-670-EXP-S (manufactured by Dainippon Ink and Chemicals Inc.); dicyclopentadiene novolak type epoxy resins such as Epiclon HP7200 (manufactured by Dainippon Ink and Chemicals Inc.); biphenyl novolak type epoxy resins such as NC-3000P (manufactured by Nippon Kayaku Co., Ltd.); naphthalene phenol novolak type epoxy resins such as ESN-165S (manufactured by Tohto Kasei Co., Ltd.); glycidyl amine type epoxy resins such as Epikote 630 (manufactured by Japan Epoxy Resin Co., Ltd.), Epiclon 430 (manufactured by Dainippon Ink and Chemicals Inc.) and TETRAD-X (manufactured by Mitsubishi Gas Chemical Company Inc.); alkylpolyol type epoxy resins such as ZX-1542 (manufactured by Tohto Kasei Co., Ltd.), Epiclon 726 (manufactured by Dainippon Ink and Chemicals Inc.), Epolight 80MFA (manufactured by Kyoeisha Chemical Co., Ltd.) and Denacol EX-611 (manufactured by Nagase ChemteX Corporation); rubber modified type epoxy resins such as YR-450, YR-207 (all manufactured by Tohto Kasei Co., Ltd.) and Epolead PB (manufactured by Daicel Chemical Industries, Ltd.); glycidyl ester compounds such as Denacol EX-147 (manufactured by Nagase ChemteX Corporation); bisphenol A type episulfide resins such as Epikote YL-7000 (manufactured by Japan Epoxy Resin Co., Ltd.); and others such as YDC-1312, YSLV-80XY, YSLV-90CR (all manufactured by Tohto Kasei Co., Ltd.), XAC4151 (manufactured by Asahi Kasei Corporation), Epikote 1031, Epikote 1032 (all manufactured by Japan Epoxy Resin Co., Ltd.), EXA-7120 (manufactured by Dainippon Ink and Chemicals Inc.), TEPIC (manufactured by Nissan Chemical Industries, Ltd.).

Moreover, examples of the epoxy (meth)acrylate available in the market include Ebecryl 3700, Ebecryl 3600, Ebecryl 3701, Ebecryl 3703, Ebecryl 3200, Ebecryl 3201, Ebecryl 3600, Ebecryl 3702, Ebecryl 3412, Ebecryl 860, Ebecryl RDX63182, Ebecryl 6040, Ebecryl 3800 (all manufactured by Daicel UCB Co., Ltd.), EA-1020, EA-1010, EA-5520, EA-5323, EA-CHD, EMA-1020 (all manufactured by Shin-Nakamura Chemical Co., Ltd.), Epoxyester M-600A, Epoxyester 40EM, Epoxyester 70PA, Epoxyester 200PA, Epoxyester 80MFA, Epoxyester 3002M, Epoxyester 3002A, Epoxyester 1600A, Epoxyester 3000M, Epoxyester 3000A, Epoxyester 200EA, Epoxyester 400EA (all manufactured by Kyoeisha Chemical Co., Ltd.), Denacol Acrylate DA-141, Denacol Acrylate DA-314, Denacol Acrylate DA-911 (all manufactured by Nagase ChemteX Corporation), and the like.

The urethane (meth)acrylate obtainable by reaction of the isocyanate with a (meth)acrylic acid derivative having a hydroxyl group can be obtained by reacting 1 equivalent amount of a compound having two isocyanate groups with 2 equivalent amount of the (meth)acrylic acid derivative having a hydroxyl group in the presence of a catalyst amount of tin compounds.

The isocyanate to be used as a material for the urethane (meth)acrylate which is obtainable by reaction of the isocyanate with the (meth)acrylic acid derivative having a hydroxyl group is not particularly limited. Examples of the isocyanate include isophorone diisocyanate, 2,4-tolylene diisocyanate, 2,6-tolylene diisocyanate, hexamethylene diisocyanate, trimethylhexamethylene diisocyanate, diphenylmethane-4,4′-diisocyanate (MDI), hydrogenated MDI, polymeric MDI, 1,5-naphthalene diisocyanate, Norbornane diisocyanate, tolidine diisocyanate, xylylene diisocyanate (XDI), hydrogenated XDI, lysine diisocyanate, triphenylmethane triisocyanate, tris(isocyanatophenyl) thiophosphate, tetramethylxylene diisocyanate, and 1,6,10-undecane triisocyanate, and the like.

The isocyanate to be used as a material for the urethane (meth)acrylate which is obtainable by reaction of the isocyanate with the (meth)acrylic acid derivative having a hydroxyl group is not particularly limited, and examples thereof further include a chain-extended isocyanate compound which is obtainable by reaction of an excess amount of an isocyanate with a polyol such as ethyleneglycol, glycerine, sorbitol, trimethyrol propane, (poly) propylene glycol, carbonatediol, polyetherdiol, polyesterdiol, and polycaprolactonediol.

The (meth)acrylic acid derivative having a hydroxyl group to be used as a material for the urethane (meth)acrylate which is obtainable by reaction of the isocyanate with the (meth)acrylic acid derivative having a hydroxyl group is not particularly limited, and examples thereof include: a commercially available product such as 2-hydroxyethyl (meth)acrylate, 2-hydroxypropyl (meth)acrylate, 4-hydroxybutyl (meth)acrylate and 2-hydroxybutyl (meth)acrylate; a mono(meth)acrylate of divalent alcohols such as ethylene glycol, propylene glycol, 1,3-propanediol, 1,3-butanediol, 1,4-butanediol and polyethylene glycol; and a mono(meth)acrylate or a di(meth)acrylate of trivalent alcohols such as trimethylolethane, trimethylolpropane and glycerin; an epoxy acrylate such as bisphenol A-modified epoxy acrylate; and the like.

Examples of the commercially available urethane (meth)acrylate include M-1100, M-1200, M-1210, M-1600 (all manufactured by Toagosei Co., Ltd.), Ebecryl 230, Ebecryl 270, Ebecryl 4858, Ebecryl 8402, Ebecryl 8804, Ebecryl 8803, Ebecryl 8807, Ebecryl 9260, Ebecryl 1290, Ebecryl 5129, Ebecryl 4842, Ebecryl 210, Ebecryl 4827, Ebecryl 6700, Ebecryl 220, Ebecryl 2220 (all manufactured by Daicel UCB Co., Ltd.), Art Resin UN-9000H, Art Resin UN-9000A, Art Resin UN-7100, Art Resin UN-1255, Art Resin UN-330, Art Resin UN-3320HB, Art Resin UN-1200TPK, Art Resin SH-500B (all manufactured by Negami Chemical Industrial Co., Ltd.), U-122P, U-108A, U-340P, U-4HA, U-6HA, U-324A, U-15HA, UA-5201P, UA-W2A, U-1084A, U-6LPA, U-2HA, U-2PHA, UA-4100, UA-7100, UA-4200, UA-4400, UA-340P, U-3HA, UA-7200, U-2061BA, U-10H, U-122A, U-340A, U-108, U-6H, UA-4000 (all manufactured by Shin-Nakamura Chemical Co., Ltd.), AH-600, AT-600, UA-306H, AI-600, UA-101T, UA-101I, UA-306T, UA-3061, and the like.

In the sealant of the present invention, the (meth)acrylic resin preferably contains a bisphenol skeleton in a content of 80% by weight or more. The content of bisphenol skeleton of less than 80% by weight possibly causes deterioration of the heat resistance or water resistance due to reduction of the glass transition temperature (Tg).

The cyclic ether group-containing resin is not particularly limited, and examples thereof include an epoxy compound containing an epoxy group, an alicyclic epoxy compound containing an alicyclic epoxy group, an oxetane compound containing an oxetane group, a furan compound, and the like. Among those examples, an epoxy compound, an alicyclic epoxy compound, and an oxetane compound are preferable from the viewpoint of the reaction speed.

The epoxy compound is not particularly limited, and examples thereof include: an epoxy compound of a novolak type such as phenol novolak type, cresol novolak type, biphenyl nobolak type, trisphenol novolak type and dicyclopentadiene novolak type; an epoxy compound of a bisphenol type such as bisphenol A type, bisphenol F type, 2,2′-diallyl bisphenol A type, hydrogenated bisphenol type and polyoxypropylene bisphenol A type; and the like. Further, other examples include glycidylamine and the like. Those epoxy compounds may be used alone or two or more of them may be used in combination.

As the epoxy compound available in the market, examples of the commercially available phenol novolak type epoxy compound include Epiclon N-740, N-770, N-775 (all manufactured by Dainippon Ink and Chemicals Inc.), Epikote 152, Epikote 154 (all manufactured by Japan Epoxy Resin Co., Ltd.), and the like. Examples of the commercially available cresol novolak type epoxy compound include Epiclon N-660, N-665, N-670, N-673, N-680, N-695, N-665-EXP and N-672-EXP (all manufactured by Dainippon Ink and Chemicals Inc.); an example of the commercially available biphenyl novolak type epoxy compound is NC-3000P (manufactured by Nippon Kayaku Co., Ltd.); examples of the commercially available trisphenol novolak type epoxy compound include EP1032S50 and EP1032H60 (all manufactured by Japan Epoxy Resin Co., Ltd.); examples of the commercially available dicyclopentadiene novolak type epoxy compound include XD-1000-L (manufactured by Nippon Kayaku Co., Ltd.) and HP-7200 (manufactured by Dainippon Ink and Chemicals Inc.); examples of the commercially available bisphenol A type epoxy compound include Epikote 828, Epikote 834, Epikote 1001, Epikote 1004 (all manufactured by Japan Epoxy Resin Co., Ltd.), Epiclon 850, Epiclon 860 and Epiclon 4055 (all manufactured by Dainippon Ink and Chemicals Inc.); examples of the commercially available bisphenol F type epoxy compound include Epikote 807 (manufactured by Japan Epoxy Resin Co., Ltd.) and Epiclon 830 (manufactured by Dainippon Ink and Chemicals Inc.); an example of the commercially available 2,2′-diallyl bisphenol A type epoxy compound is RE-810NM (manufactured by Nippon Kayaku Co., Ltd.); an example of the commercially available hydrogenated bisphenol type epoxy compound is ST-5080 (manufactured by Tohto Kasei Co., Ltd.); examples of the commercially available polyoxypropylene bisphenol A type epoxy compound include EP-4000 and EP-4005 (all manufactured by ADEKA Corporation); and the like.

Examples of the glycidylamine available in the market include Epiclon 430 (manufactured by Dainippon Ink and Chemicals Inc.), TETRAD-C, TETRAD-X (all manufactured by Mitsubishi Gas Chemical Company Inc.), Epikote 604, Epikote 630 (all manufactured by Japan Epoxy Resin Co., Ltd.), and the like.

Examples of the oxetane compound available in the market include Eternacoll EHO, Eternacoll OXBP, Eternacoll OXTP, Eternacoll OXMA (all manufactured by Ube Industries Ltd.), and the like.

The alicyclic epoxy compound is not particularly limited, and examples thereof include Celoxide 2021, Celoxide 2080, Celoxide 3000 (all manufactured by Daicel UCB Co., Ltd.), and the like.

It is preferable that the cyclic ether group-containing resin is partially (meth)acrylated by substitution of 20% or more of the epoxy groups with acrylic groups (conversion ratio). This is because, the light-heat curing property of the sealant of the present invention is further improved. When the ratio is less than 20%, almost no improvement occurs in the light-heat curing property. The compound in which the cyclic ether group-containing resin is partially (meth)acrylated refers to a compound in which (meth)acrylic acid and part of epoxy groups of the epoxy compound having two or more epoxy groups are esterified with the (meth)acrylic acid (hereinafter also referred to as a partially acrylated epoxy resin). A preferable upper limit of the conversion rate is 80%, and a more preferable lower limit is 40% and a more preferable upper limit is 60%.

The partially acrylated epoxy resin can be obtained by reaction of, for example, an epoxy resin with a (meth)acrylic acid in the presence of a basic catalyst according to a known method.

The epoxy compound to be used as a material of the partially acrylated epoxy resin is not particularly limited, and examples of the epoxy compound include: bisphenol A type epoxy resins such as Epikote 828EL and Epikote 1004 (all manufactured by Japan Epoxy Resin Co., Ltd.); bisphenol F type epoxy resins such as Epikote 806 and Epikote 4004 (all manufactured by Japan Epoxy Resin Co., Ltd.); bisphenol S type epoxy resins such as Epiclon EXA1514 (manufactured by Dainippon Ink and Chemicals Inc.); 2,2′-diallyl bisphenol A type epoxy resins such as RE-810NM (manufactured by Nippon Kayaku Co., Ltd.); hydrogenated bisphenol type epoxy resins such as Epiclon EXA7015 (manufactured by Dainippon Ink and Chemicals Inc.); propyleneoxide-added bisphenol A type epoxy resins such as EP-4000S (manufactured by ADEKA Corporation); resorcinol type epoxy resins such as EX-201 (manufactured by Nagase ChemteX Corporation); biphenyl type epoxy resins such as Epikote YX-4000H (manufactured by Japan Epoxy Resin Co., Ltd.); sulfide type epoxy resins such as YSLV-50TE (manufactured by Tohto Kasei Co., Ltd.); ether type epoxy resins such as YSLV-80DE (manufactured by Tohto Kasei Co., Ltd.); dicyclopentadiene type epoxy resins such as EP-4088S (manufactured by ADEKA Corporation); naphthalene type epoxy resins such as Epiclon HP4032 and Epiclon EXA-4700 (all manufactured by Dainippon Ink and Chemicals Inc.); phenol novolak type epoxy resins such as Epiclon N-770 (manufactured by Dainippon Ink and Chemicals Inc.); orthocresol novolak type epoxy resins such as Epiclon N-670-EXP-S (manufactured by Dainippon Ink and Chemicals Inc.); dicyclopentadiene novolak type epoxy resins such as Epiclon HP7200 (manufactured by Dainippon Ink and Chemicals Inc.); biphenyl novolak type epoxy resins such as NC-3000P (manufactured by Nippon Kayaku Co., Ltd.); naphthalene phenol novolak type epoxy resins such as ESN-165S (manufactured by Tohto Kasei Co., Ltd.); glycidyl amine type epoxy resins such as Epikote 630 (manufactured by Japan Epoxy Resin Co., Ltd.), Epiclon 430 (manufactured by Dainippon Ink and Chemicals Inc.) and TETRAD-X (manufactured by Mitsubishi Gas Chemical Company Inc.); alkylpolyol type epoxy resins such as ZX-1542 (manufactured by Tohto Kasei Co., Ltd.), Epiclon 726 (manufactured by Dainippon Ink and Chemicals Inc.), Epolight 80MFA (manufactured by Kyoeisha Chemical Co., Ltd.) and Denacol EX-611 (manufactured by Nagase ChemteX Corporation); rubber modified type epoxy resins such as YR-450, YR-207 (all manufactured by Tohto Kasei Co., Ltd.) and Epolead PB (manufactured by Daicel Chemical Industries, Ltd.); glycidyl ester compounds such as Denacol EX-147 (manufactured by Nagase ChemteX Corporation); bisphenol A type episulfide resins such as Epikote YL-7000 (manufactured by Japan Epoxy Resin Co., Ltd.); and others such as YDC-1312, YSLV-80XY, YSLV-90CR (all manufactured by Tohto Kasei Co., Ltd.), XAC4151 (manufactured by Asahi Kasei Corporation), Epikote 1031, Epikote 1032 (all manufactured by Japan Epoxy Resin Co., Ltd.), EXA-7120 (manufactured by Dainippon Ink and Chemicals Inc.), TEPIC (manufactured by Nissan Chemical Industries, Ltd.).

An example of the partially acrylated epoxy resin available in the market is UVACURE 1561 (manufactured by Daicel-Cytec Company Ltd.).

The cyclic ether group-containing resin preferably contains two or more cyclic ether groups such as epoxy group or oxetane group in one molecule. When the two or more cyclic ether groups are contained in one molecule, the amount of the residual unreacted compound after polymerization or cross-linking reaction becomes extremely low, with the result that contamination of the liquid crystal due to the residual unreacted compound can be suppressed. Preferably, the number of the cyclic ether groups contained in one molecule is 6 or less, because more than 6 cyclic ether groups causes larger curing and contraction, and thus possibly results in deterioration of the adhesive strength.

Preferably, the (meth)acrylic resin and the cyclic ether group-containing resin are concomitantly used in the sealant of the present invention. The sealant of the present invention of this kind has a higher glass-transition temperature of the resin due to the (meth)acrylic resin contained therein, which is cured upon irradiation of ultraviolet rays, and thus achieves a good heat resistance and water resistance. Moreover, when the sealant of the present invention is applied to a substrate having thereon a shaded part formed by wires and the like, and the sealant in the shaded part remains uncured due to blocking of light, by containing the heat-curing cyclic ether group-containing resin in the sealant, the uncured part can be cured by heating so that contamination of the liquid crystal can be excellently prevented from occurring.

In the concomitant use of the (meth)acrylic resin and the cyclic ether group-containing resin in the sealant of the present invention, the respective contents of those resins are not particularly limited. Providing that the content of one of the (meth)acrylic resin and the cyclic ether group-containing resin is 100 parts by weight, a preferable lower limit of the other resin is 10 parts by weight and a preferable upper limit of the other resin is 200 parts by weight. In the case where the other resin is the (meth)acrylic resin, the content thereof less than 10 parts by weight possibly deteriorates the dispensation property of the sealant of the present invention, and the content of more than 200 parts by weight cannot sufficiently cures the sealant and the sealant becomes soft upon irradiation of ultraviolet rays in the production of the liquid crystal display element according to the one drop fill process by using the sealant of the present invention, possibly contaminating the liquid crystal. On the other hand, in the case where the other resin is the cyclic ether group-containing resin, the content thereof less than 10 parts by weight cannot sufficiently cure the sealant upon heating for curing, and the sealant becomes soft in the production of the liquid crystal display element according to the one drop fill process using the sealant of the present invention, possibly contaminating the liquid crystal. The content of more than 200 parts by weight possibly deteriorates the dispensation property of the sealant of the present invention. A more preferable lower limit of the aforementioned other resin is 20 parts by weight.

In the sealant for one drop fill process according to the first present invention, in consideration of improvement of the pot life, the (meth)acrylic resin and/or the cyclic ether group-containing resin are/is preferably selected from those resins having a small compatibility with the heat-curing agent represented by the general formula (1). An example of the (meth)acrylic resin and/or the cyclic ether group-containing resin is a resin compound having an aromatic basic skeleton.

In the sealant for one drop fill process according to the first present invention, it is preferable that the resins having an aromatic basic skeleton be contained in an amount of 50% by weight or more of the resins contained therein.

Moreover, when the sealant includes the (meth)acrylic resin and/or the cyclic ether group-containing resin that have an aromatic basic skeleton, a preferable ratio (molar ratio) of the epoxy group and the acrylic group is 4:6 to 0:10

It is preferable that a photoradical polymerization initiator is further contained in the sealant of the present invention.

The photoradical polymerization initiator is not particularly limited as long as it induces a reaction of the (meth)acrylic resin by light irradiation, and examples of the photo-radical polymerization initiator include benzophenone, 2,2-diethoxyacetophenone, benzyl, benzoyl isopropyl ether, benzyl dimethyl ketal, 1-hydroxycyclohexyl phenyl ketone, and thioxanthone. Further, it is preferable to use the photoradical polymerization initiator having a reactive double bond and a photoreaction initiating part, because the elution of the photoradical polymerization initiator to a liquid crystal can be avoided. Among the above examples, a benzoin (ether) compound having a reactive double bond such as (meth)acryl residues together with a hydroxyl group and/or an urethane bond is particularly preferable. Here, the benzoin (ether) compound refers to benzoins and benzoin ethers.

The blending amount of the photoradical polymerization initiator is not particularly limited, and a preferable lower limit is 0.1 parts by weight and a preferable upper limit is 10 parts by weight to 100 parts by weight of the (meth)acrylic resin. The amount of lower than 0.1 parts by weight may cause lack of the capability to initiate photoradical polymerization, and thus a sufficient effect may not be obtained in some cases. On the other hand, the amount of more than 10 parts by weight may result in many of the photoradical polymerization initiators left unreacted, and thus the weathering resistance of the sealant of the present invention may be deteriorated in some cases. A more preferable lower limit is 1 part by weight, and a more preferable upper limit is 5 parts by weight.

The sealant of the present invention may contain fine particles. By containing fine particles, the sealant of the present invention has a higher viscosity and an improved thixotropy, with the result that contamination of the liquid crystal can be further reduced during the production of the liquid crystal display element according to one drop fill process.

The fine particles are not particularly limited, and any of inorganic fine particles and organic fine particles can be used.

Examples of the inorganic fine particles include silica, diatomaceous earth, alumina, zinc oxide, iron oxide, magnesium oxide, tin oxide, titanium oxide, magnesium hydroxide, aluminum hydroxide, magnesium carbonate, barium sulfate, gypsum, calcium silicate, talc, glass beads, sericite activated clay, bentonite, aluminum nitride, silicon nitride, and the like.

Examples of the organic fine particles include acrylic beads such as polymethyl methacrylate beads, polystyrene beads such as cross-linking polystyrene beads, polycarbonate beads, melamine-formalin beads, benzoguanamine-formalin beads, hollow particles.

The particle diameter of the fine particle is not particularly limited, and a preferable lower limit is 0.01 μm and a preferable upper limit is 5 μm. When the particle diameter is within the aforementioned range, the surface area of the fine particles becomes sufficiently large for the (meth)acrylic acid and the like, and thus workability for gap formation between substrates can be guaranteed in the production of the liquid crystal display element.

The structure of the fine particles is not particularly limited, and examples thereof include any structure such as a solid-core structure, a hollow structure, and a core-shell structure having a core layer and a shell layer covering the core layer.

When the fine particles are organic fine particles having the core-shell structure, the method of producing the fine particles is not particularly limited. There may be exemplified a method in which core particles are formed according to an emulsion polymerization method by only using monomers constituting the core layer, and then monomers constituting the shell layer are added thereto for polymerization so that a shell layer is formed on the surface of the core particles, and the like.

In the case where the sealant of the present invention contains the fine particles, the blending amount of the fine particles is not particularly limited, and a preferable lower limit is 15 parts by weight and a preferable upper limit is 50 parts by weight to 100 parts by weight of the total amount of the (meth)acrylic resin and the cyclic ether group-containing resin. When the amount is less than 15 parts by weight, the sealant of the present invention may not be bestowed with a sufficient effect to improve the adhesiveness, and the amount of more than 50 parts by weight may cause an unnecessarily large increase in the viscosity of the sealant of the present invention. A more preferable upper limit of the blending amount is 20 parts by weight.

The sealant of the present invention may contain a silane coupling agent. By containing a silane coupling agent, it is possible to improve the adhesiveness between the sealant of the present invention and the substrate.

Although the silane coupling agent is not particularly limited, preferable examples thereof include γ-aminopropyltrimethoxysilane, γ-mercaptopropyltrimethoxysilane, γ-glycidoxypropyltrimethoxysilane, γ-isocyanatepropyltrimethoxysilane, etc.; an imidazolesilane compound having a structure in which an imidazole skeleton and an alkoxysilyl compound are bonded via a spacer group; and the like. This is because, the aforementioned examples have an excellent effect of improving the adhesiveness with the substrate and the like, and it is possible to prevent the sealant from eluting into the liquid crystal materials by chemical bonding with the (meth)acrylic resin and the cyclic ether group-containing resin. Those silane coupling agents may be used alone or two or more of them may be used in combination.

The sealant of the present invention may contain, if necessary, a reactive diluent for viscosity control, a thixotropic agent for controlling the thixotropy, a spacer such as polymer beads to adjust panel gaps, a curing accelerator such as 3-P-chlorophenyl-1,1-dimethyl urea, a defoaming agent, a leveling agent, a polymerization inhibitor, other additives.

A preferable lower limit of the viscosity of the sealant of the present invention is 100000 mPa·s and a preferable upper limit of the viscosity of the sealant of the present invention is 400000 mPa·s, when measured by using an E-type viscometer at 1.0 rpm at a temperature of 25° C. When the viscosity is less than 100000 mPa·s, it may be impossible to maintain the formed seal patterns until the sealant is heat-cured in the production of the liquid crystal display element according to one drop fill process using the sealant of the present invention, whereas when the viscosity is more than 400000 mPa·s, application with a dispenser becomes difficult, possibly deteriorating the working property. Here, an example of the E-type Viscometer is 5×HBDV-III+CP (product name), Roter No. CP-51, manufactured by Brookfield Engineering Laboratories, Inc.

In the sealant of the present invention, a preferable lower limit of the thixotropic index (TI value) is 1.0 and an preferable upper limit of the TI value is 2.0. The TI value of less than 1.0 increases the viscosity of the sealant of the present invention at the time of application, and the TI value of more than 2.0 makes defoaming difficult. In the present specification, the “thixotropic index (TI value)” refers to a value obtained by dividing the viscosity measured using an E-type viscometer at 0.5 rpm at a temperature of 25° C. by the viscosity measured using the same E-type viscometer at 5.0 rpm at the same temperature.

In the sealant of the present invention, the glass transition temperature of the cured sealant is preferably 80° C. or more when measured by dynamic mechanical analysis (DMA) under conditions of a temperature rising rate of 5° C./min and of a frequency of 10 Hz. The glass transition temperature of less than 80° C. may deteriorate the adhesiveness or increase the water-absorbing property under a high temperature and high humidity condition. The upper limit of the glass transition temperature is not particularly limited, and a preferable upper limit is 180° C. When the glass transition temperature is more than 180° C., the cured sealant of the present invention becomes too hard so that the cured sealant of the present invention may not have a sufficient adhesive force in some cases. A more preferable upper limit is 150° C.

The sealant of the present invention preferably has an adhesive strength of 150 N/cm² or more when it is used to attach the glass substrates and is cured. In the case where the adhesive strength is less than 150 N/cm², the strength of the liquid crystal display element to be produced by using the sealant of the present invention may become insufficient in some cases.

The sealant of the present invention preferably has a dielectric constant of 3 or more when measured under conditions of a volume resistance of the cured product of 1×10¹³ Ω·cm, and 100 kHz. The volume resistance of less than 1×10¹³ Ω·cm indicates that the sealant of the present invention contains ionic impurities. In this case, use of the sealant, for example, as a transfer material may cause elution of the ionic impurities into the liquid crystal upon power distribution and have an influence on a liquid crystal drive voltage, thus possibly causing an uneven display. Moreover, since a normal dielectric constant of the liquid crystals is approximately 10 in ∈//(parallel) and approximately 3.5 in ∈⊥ (vertical), the dielectric constant of less than 3 may cause elution of the sealant of the present invention into the liquid crystal upon power distribution and have an influence on the liquid crystal drive voltage, thus possibly causing an uneven display.

The method of producing this kind of sealant of the present invention is not particularly limited. For example, there may be exemplified a method in which the heat-curing agent represented by any of the general formulae (1) to (16), a (meth)acrylic resin, a cyclic ether group-containing resin, a photoradical polymerization initiator and optionally an additive are mixed by a commonly known method, and the like. At the time of the mixing, those materials may be contacted with an ion absorptive solid such as layers of silicate solid to remove ionic impurities.

Since the sealant of the present invention contains the heat-curing agent represented by any of the general formulae (1) to (16), the heating temperature for curing can be set at approximately 120° C. for 1 hour, in the production of the liquid crystal display element according to one drop fill process, with the result that the resulting sealant has an excellent pot life as well as hardly contaminates the liquid crystal. Furthermore, since the number of carbon between the hydrazide groups is limited to the specific range in the heat-curing agent, the liquid crystal display element formed by using the sealant of the present invention can prevent generation of small light leakage in the vicinity of the cured sealant and the liquid crystal, and thus high quality display images can be obtained.

It is possible to produce a transfer material by blending conductive fine particles in the sealant of the present invention. By using the transfer material, electrodes of a transparent substrate are conductively connected without contaminating the liquid crystal.

The transfer material containing the sealant of the present invention and the conductive fine particles is also included in the present invention.

The conductive fine particles are not particularly limited, and usable examples thereof include those prepared by forming a conductive metal layer on the surface of metal balls or resin fine particles, and the like. The conductive fine particles prepared by forming a conductive metal layer on the surface of the resin fine particles are especially preferable, since it is possible to conductively connect the transparent substrates and the like without causing any damage on the substrate due to the excellent elasticity of the resin fine particles.

The liquid crystal display element formed by using the sealant for one drop fill process of the present invention and/or the transfer material of the present invention is also included in the present invention.

The method of producing the liquid crystal display element by using the sealant and the transfer material of the present invention is not particularly limited, and an example thereof includes the following method.

That is, the sealant of the present invention is applied to one of two sheets of transparent substrates such as an ITO thin film having an electrode by screen printing or application with a dispenser, or the like to form a rectangular seal pattern. Further, the transfer material of the present invention is applied to the other transparent substrate by screen printing or application with a dispenser or the like to form a pattern at predetermined positions.

Next, in a state the sealant is not yet cured, small droplets of a liquid crystal are dropped and applied to the entire face within a frame of the transparent substrate, and the other substrate is immediately laminated thereon while the transfer material is not cured, and then the sealant part and the transfer material part are irradiated with ultraviolet rays to cure the sealant and the transfer material. The sealant and the transfer material of the present invention are further heated for curing in an oven at 100° C. to 200° C. for one hour to complete the curing, so that a liquid crystal display element is produced.

### EFFECTS OF THE INVENTION

By using the resin composition of the present invention having the aforementioned configuration, it is possible to provide a sealant for one drop fill process, a transfer material, and a liquid crystal display element, each having an excellent pot life, hardly contaminating a liquid crystal, making it possible to produce a liquid crystal display device with high quality display images.

### BEST MODE FOR CARRYING OUT THE INVENTION

The present invention will be described in more detail below by way of Examples, but the present invention is not limited to those Examples.

### Example 1

A partially acrylated epoxy resin (UVAC1561, manufactured by Daicel UCB) in an amount of 40 parts by weight, 20 parts by weight of a bisphenol A epoxy acrylate resin (EB3700, manufactured by Daicel UCB), and 2 parts by weight of a radical polymerization initiator (Irgacure 651, manufactured by Ciba Specialty Chemicals Inc.) were blended, and dissolved by heating at 80° C., and then stirred with a planetary stirring apparatus to obtain a mixture.

Next, the mixture was blended with 15 parts by weight of a spherical silica (SO-Cl, manufactured by Admatechs Co., Ltd.) serving as a filler, 5 parts by weight of a heat-curing agent (OADH: oxalyl dihydrazide, manufactured by Japan Finechem Company, Inc.), and 1 part by weight of a coupling agent (KBM403, manufactured by Shin-Etsu Chemical Co., Ltd.), stirred with a planetary stirring apparatus, and then dispersed with ceramic three rolls to obtain a sealant.

Spacer fine particles (Micropearl SP-2055, manufactured by Sekisui Chem. Co., Ltd.) in an amount of 1 part by weight were dispersed in 100 parts by weight of the sealant obtained above to prepare a sealant for one drop fill process, and the sealant was applied with a dispenser to form a rectangular pattern on one of two glass substrates that was previously rubbed, with an alignment film and a transparent electrode formed thereon.

Thereafter, small drops of a liquid crystal (JC-5001LA, manufactured by Chisso Corporation) were dropped and applied to the entire face within a frame of the sealant on the glass substrate having an transparent electrode. The entire substrate was then placed in an atmosphere in which the pressure was reduced to 1.5 Pa by taking 30 minutes, and after the other glass substrate having a transparent electrode was further laminated thereon, the pressure was returned to a normal pressure. Next, by using a high pressure mercury lamp equipped with a filter to block light of 350 nm or lower, the sealant-applied part was irradiated with light at 100 mW/cm² for 30 seconds, and heated (120° C., 1 hour) for curing so that a liquid crystal display element was obtained.

### Example 2

A liquid crystal display element was obtained in the same manner as in Example 1, except that MDH (malonic acid dihydrazide, manufactured by Japan Finechem Company, Inc) was used as a heat-curing agent in place of the OADH.

### Example 3

A liquid crystal display element was obtained in the same manner as in Example 1, except that MADH (malic acid dihydrazide, manufactured by Japan Finechem Company, Inc) was used as a heat-curing agent in place of the OADH.

### Example 4

A liquid crystal display element was obtained in the same manner as in Example 1, except that TADH (tartaric acid dihydrazide, manufactured by Japan Finechem Company, Inc) was used as a heat-curing agent in place of the OADH.

### Example 5

A liquid crystal display element was obtained in the same manner as in Example 1, except that the heat-curing agent was replaced with a compound having a structure represented by the following chemical formula (18).

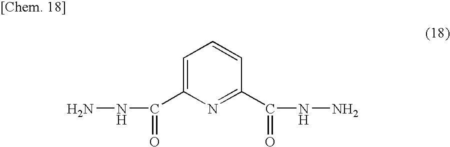

### Comparative Example 1

A liquid crystal display element was obtained in the same manner as in Example 1, except that ADH (adipic acid dihydrazide, manufactured by Japan Finechem Company, Inc) was used as a heat-curing agent in place of the OADH.

### Comparative Example 2

A liquid crystal display element was obtained in the same manner as in Example 1, except that SDH (sebacic acid dihydrazide, manufactured by Japan Finechem Company, Inc) was used as a heat-curing agent in place of the OADH.

### Comparative Example 3

A liquid crystal display element was obtained in the same manner as in Example 1, except that VDH (1,3-bis(hydrazinocarboethyl)-5-isopropylhydantoin, manufactured by Ajinomoto Co., Inc.) was used as a heat-curing agent in place of the OADH.

### (Evaluation)

The following evaluations were performed on the sealants and the liquid crystal display elements obtained in the Examples and the Comparative Examples.

### (Pot Life)

A viscosity of the sealants obtained in the above Examples and Comparative Examples after stored at 23° C. for 24 hours and an initial viscosity of the sealants immediately after production were measured, and each of the sealants was evaluated based on the value of (viscosity after stored at 23° C. for 24 hours)/(initial viscosity). Table 1 shows the results.

The viscosity of the sealants was measured by using an E-type viscometer at 1.0 rpm. In Table 1, “◯” indicates that the obtained value was 1.10 or less, and “X” indicates that the obtained value was more than 1.10.

### (Contamination of Liquid Crystal, Resistivity Retention Ratio)

An amount of 1.0 g of a liquid crystal (JC-5001LA, manufactured by Chisso Corporation) was placed in a sample bottle, and then 0.02 g of the sealant obtained in any of Examples and Comparative Examples was added and stirred, followed by heating at 120° C. for 1 hour. After the temperature was lowered to room temperature (25° C.), the liquid crystal resistivity of liquid crystal portions was measured with a liquid crystal resistivity measurement apparatus (6517A, manufactured by KEITHLEY Instruments, Inc.) using an electrode for a liquid (LE-21 type, manufactured by Ando Denki Co.) in standard temperature and humidity conditions (20° C., 65% RH). The liquid crystal resistivity retention ratio was calculated according to the equation mentioned below. Table 1 shows the results.

In Table 1, “◯” indicates the resistivity retention ratio of liquid crystal of more than 0.1, and “Δ” indicates the resistivity retention ratio of liquid crystal of 0.1 or less.

Resistivity retention ratio of liquid crystal=(resistivity of used liquid crystal after addition of the sealant/resistivity of used liquid crystal with no addition of the sealant)×100

### (Contamination of Liquid Crystal, Light Leakage)

Vibration or pressure was applied several times to a vicinity of a contacting portion between the liquid crystal of the liquid crystal display element and the sealant obtained in the respective Examples or Comparative Examples. Thereafter, microscopic observation was performed through a polarizing plate in the vicinity of the contacting portion. The liquid crystal was judged to be contaminated when small light leakage was observed. Table 1 shows the results.

On the other hand, the sealants prepared in each of Examples and Comparative Examples and glass substrates at a temperature of 23° C. or 50° C. were used to produce liquid crystal display elements in a vacuum of 1.5 Pa or 5.0 Pa. In the same manner as mentioned above, occurrence of light leakage was observed. Table 1 shows the results. In Table 1, “◯” indicates no occurrence of light leakage, “Δ” indicates occurrence of partial light leakage, and “X” indicates occurrence of light leakage in the vicinity of the display element.

### (Viscosity Measurement)

The viscosity of the sealant prepared in each of Examples and Comparative Examples was measured by using an E-type viscometer at 1.0 rpm at a temperature of 25° C. Table 1 shows the results.

### (Measurement of Thixotropic Index (TI Value))

The TI value of the sealant prepared in each of Examples and Comparative Examples was calculated by dividing the viscosity of the sealant measured by an E-type viscometer at 0.5 rpm at a temperature of 25° C. by the viscosity measured by the same E-type viscometer at 5.0 rpm at the same temperature. Table 1 shows the results.

TABLE 1

| | | | Exam- | Exam- | Exam- | Exam- | Exam- | Comparative | Comparative | Comparative |
|---|---|---|---|---|---|---|---|---|---|---|
| Evaluation Items | | | ple 1 | ple 2 | ple 3 | ple 4 | ple 5 | Example 1 | Example 2 | Example 3 |
| Pot life | | | ∘: 1.04 | ∘: 1.03 | ∘: 1.09 | ∘: 1.00 | ∘: 1.03 | ∘: 1.02 | ∘: 1.03 | x: 1.48 |
| Contamination of liquid crystal | | | ∘: 0.37 | Δ: 0.1 | ∘: 0.44 | ∘: 0.48 | Δ: 0.1 | ∘: 1.77 | ∘: 0.4 | Δ: 0.07 |
| (resistivity retention ratio) | | | | | | | | | | |
| Contamination | After application of | | ∘ | ∘ | ∘ | ∘ | ∘ | x | x | ∘ |
| of liquid crystal | vibration or pressure | | | | | | | | | |
| (Light leakage) | Glass | 1.5 Pa | ∘ | ∘ | ∘ | ∘ | ∘ | x | x | ∘ |
| | temperature | 5 Pa | ∘ | ∘ | ∘ | ∘ | ∘ | ∘~Δ | ∘~Δ | ∘ |
| | 23° C. | | | | | | | | | |
| | Glass | 1.5 Pa | ∘ | ∘ | ∘ | ∘ | ∘ | x | x | ∘ |
| | temperature | 5 Pa | ∘ | ∘ | ∘ | ∘ | ∘ | x | x | ∘ |
| | 50° C. | | | | | | | | | |

| | | | | | | | | | |
|---|---|---|---|---|---|---|---|---|---|
| Viscosity | 0.5 rpm | 223000 | 233000 | 226000 | 230000 | 216000 | 221000 | 227000 | 231000 |
| (Pa · s) | 1.0 rpm | 220000 | 229000 | 221000 | 227000 | 219000 | 217000 | 224000 | 229000 |
| | 5.0 rpm | 216000 | 220000 | 218000 | 223000 | 209000 | 213000 | 222000 | 226000 |

| | | | | | | | | |
|---|---|---|---|---|---|---|---|---|
| TI value | 1.03 | 1.06 | 1.04 | 1.03 | 1.03 | 1.04 | 1.02 | 1.02 |

### INDUSTRIAL APPLICABILITY

According to the present invention, it is possible to provide a sealant for one drop fill process, having an excellent pot life, hardly contaminating a liquid crystal, making it possible to produce a liquid crystal display device with high quality display images, and also provide a transfer material and a liquid crystal display element.

1-12. (canceled)

13. A sealant for one drop fill process,
which comprises a (meth)acrylic resin and a cyclic ether group-containing resin, and a heat-curing agent having a structure represented by the following general formula (1), 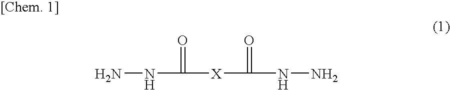
in the formula (1), X represents a structure represented by (CHR)ₙ, R represents OH and/or H, and n represents an integer of 0 to 3,
wherein the (meth)acrylic resin is an epoxy(meth)acrylate in which the conversion ratio from epoxy groups to acrylic groups is almost 100%, and the cyclic ether group-containing resin is a partially (meth)acrylated epoxy resin in which 20% to 80% of epoxy groups are substituted with acrylic groups.

14. The sealant for one drop fill process according to claim 13,
wherein X represents a structure represented by CH₂—CH(OH) in the general formula (1).

15. A sealant for one drop fill process,
which comprises a (meth)acrylic resin and a cyclic ether group-containing resin, and at least one kind of a heat-curing agent selected from the group consisting of the following chemical formulae (2) to (11), 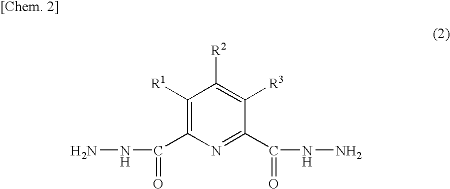
in the formula (2), R¹, R² and R³ each represents any of H, (CH₂)ₙCH₃, OH, COOH and NH₂, and n represents an integer of 0 to 2, 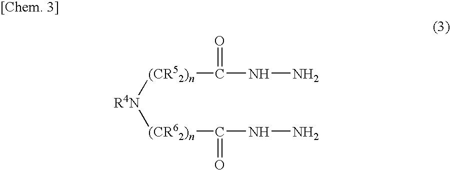
in the formula (3), R⁴, R⁵ and R⁶ each represents any of H, (CH₂)ₙCH₃, OH, COOH and NH₂, and n represents an integer of 4 or less, 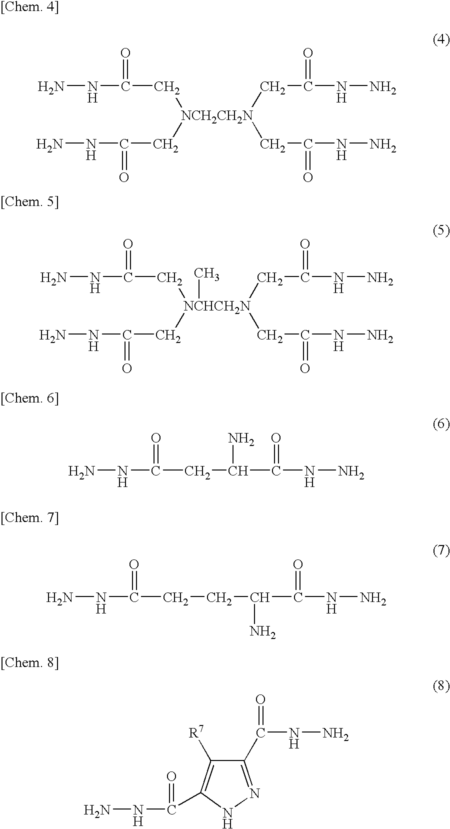
in the formula (8), R⁷ represents any of H, (CH₂)ₙCH₃, OH, COOH and NH₂, and n represents an integer of 0 to 2, 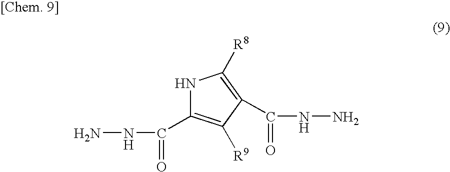
in the formula (9), R⁸ and R⁹ each represents any of H, (CH₂)ₙCH₃, OH, COOH and NH₂, and n represents an integer of 0 to 2, 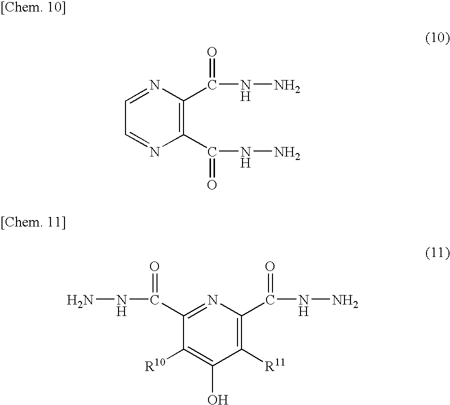
in the formula (11), R¹⁰ and R¹¹ each represents any of H, (CH₂)ₙCH₃, OH, COOH and NH₂, and n represents an integer of 0 to 2,
wherein the (meth)acrylic resin is an epoxy(meth)acrylate in which the conversion ratio from epoxy groups to acrylic groups is almost 100%, and the cyclic ether group-containing resin is a partially (meth)acrylated epoxy resin in which 20% to 80% of epoxy groups are substituted with acrylic groups.

16. A sealant for one drop fill process,
which comprises a (meth)acrylic resin and a cyclic ether group-containing resin, and at least one kind of a heat-curing agent selected from the group consisting of the following chemical formulae (12) to (15), 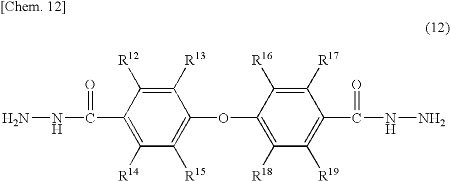
in the formula (12), R¹² to R¹⁹ each represents any of H, (CH₂)ₙCH₃, OH, COOH and NH₂, and n represents an integer of 0 to 2, 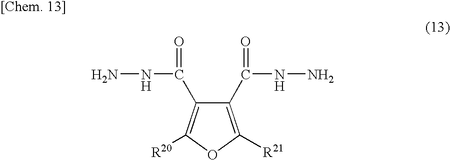
in the formula (13), R²⁰ and R²¹ each represents any of H, (CH₂)ₙCH₃, OH, COOH and NH₂, and n represents an integer of 0 to 2, 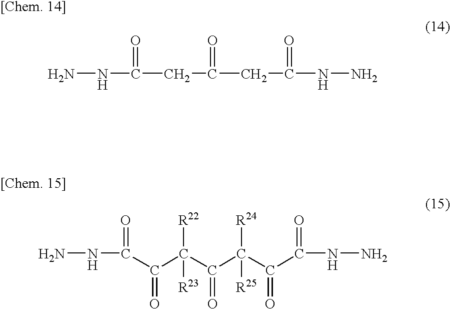
in the formula (15), R²² to R²⁵ each represents any of H, (CH₂)ₙCH₃, OH, COOH and NH₂, and n represents an integer of 0 to 2,
wherein the (meth)acrylic resin is an epoxy(meth)acrylate in which the conversion ratio from epoxy groups to acrylic groups is almost 100%, and the cyclic ether group-containing resin is a partially (meth)acrylated epoxy resin in which 20% to 80% of epoxy groups are substituted with acrylic groups.

17. A sealant for one drop fill process,
which comprises a (meth)acrylic resin and a cyclic ether group-containing resin, and a heat-curing agent having a structure represented by the following chemical formula (16), 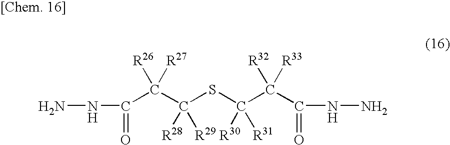
in the formula (16), R²⁶ to R³³ each represents any of H, (CH₂)ₙCH₃, OH, COOH and NH₂, and n represents an integer of 0 to 2,
wherein the (meth)acrylic resin is an epoxy(meth)acrylate in which the conversion ratio from epoxy groups to acrylic groups is almost 100%, and the cyclic ether group-containing resin is a partially (meth)acrylated epoxy resin in which 20% to 80% of epoxy groups are substituted with acrylic groups.

18. The sealant for one drop fill process according to claim 13, 14, 15, 16, or 17,
which further comprises a photoradical polymerization initiator.

19. The sealant for one drop fill process according to claim 13, 14, 15, 16, or 17,
wherein said (meth)acrylic resin contains a bisphenol skeleton in a content of 80% by weight or more.

20. The sealant for one drop fill process according to claim 13, 14, 15, 16, or 17,
wherein 20% by weight or more of said cyclic ether group-containing resin is partially (meth)acrylated.

21. The sealant for one drop fill process according to claim 13, 14, 15, 16, or 17,
which has a viscosity of 100000 to 400000 mPa·s measured by using an E-type viscometer at 1.0 rpm at a temperature of 25° C.

22. The sealant for one drop fill process according to claim 13, 14, 15, 16, or 17,
which has a thixotropic index (TI value) of 1.0 to 2.0.

23. A transfer material,
which comprises the sealant for one drop fill process according to claim 13, 14, 15, 16, or 17, and conductive fine particles.

24. A liquid crystal display element,
which is formed by using the sealant for one drop fill process according to claim 13, 14, 15, 16, or 17.

25. A liquid crystal display element,
which is formed by using the transfer material according to claim 23.
